(19) United States
(12) Patent Application Publication
(10) Pub. No.: US 2005/0009975 A1
(43) Pub. Date: Jan. 13, 2005

(54) Resin composition having high dielectric constant and uses thereof

(76) Inventors: Tsai Fa Hsu, Tainan City (TW); Ying-Ting Shih, Tainan City (TW); Ming-Yi Tsai, Kaohsiung City (TW)

Correspondence Address: SCULLY SCOTT MURPHY & PRESSER, PC, 400 GARDEN CITY PLAZA, GARDEN CITY, NY, 11530, US

(21) Appl. No.: 10/846,317

(22) Filed: May 14, 2004

(30) Foreign Application Priority Data
May 14, 2003 (TW) 092113093

(51) Int. Cl. C08K 3/10; C08K 3/18

(52) U.S. Cl. 524/430; 524/437

(57) ABSTRACT

The subject invention relates to a resin composition having a high dielectric constant, comprising (a) an epoxy resin, (b) a curing agent, (c) a ceramic powder, and (d) a highly polar modifier. The subject invention further relates to a process for the manufacture of a printed circuit board comprising using the composition of the subject invention as a material for a capacitor material embedded in the printed circuit board.

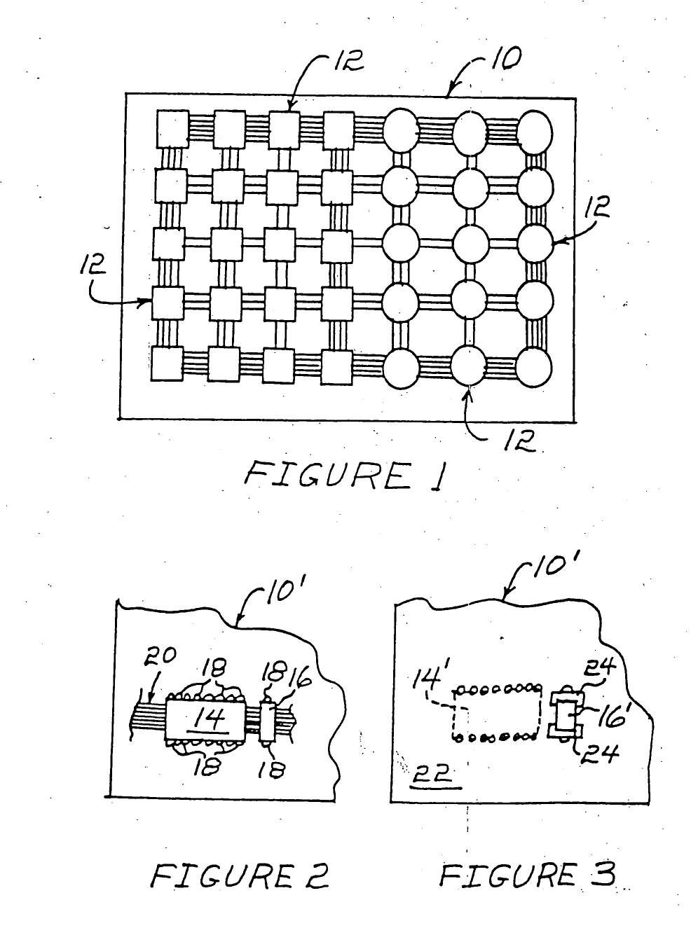

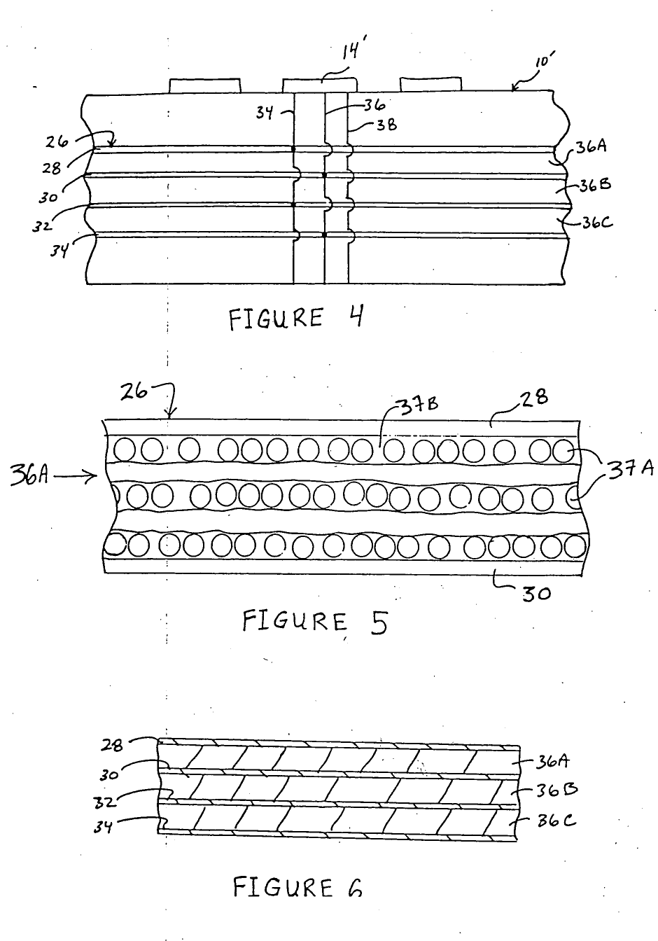

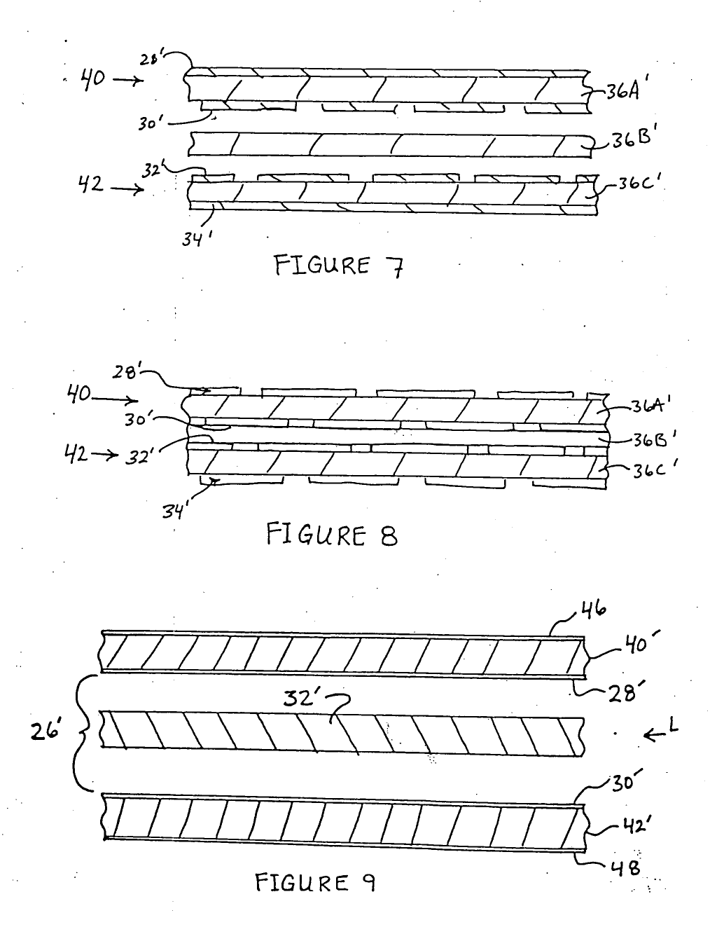

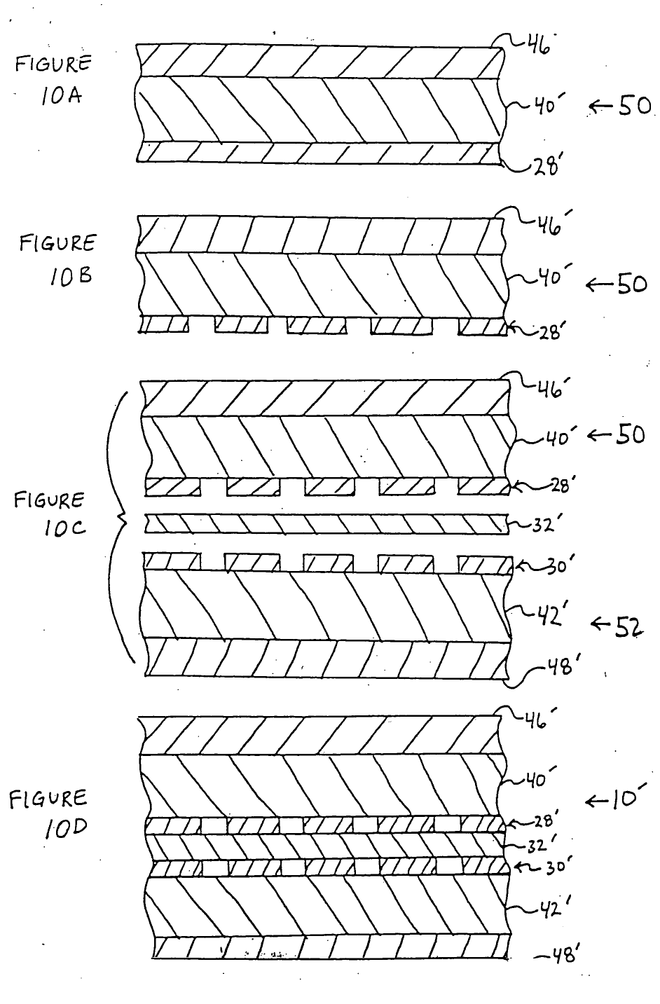

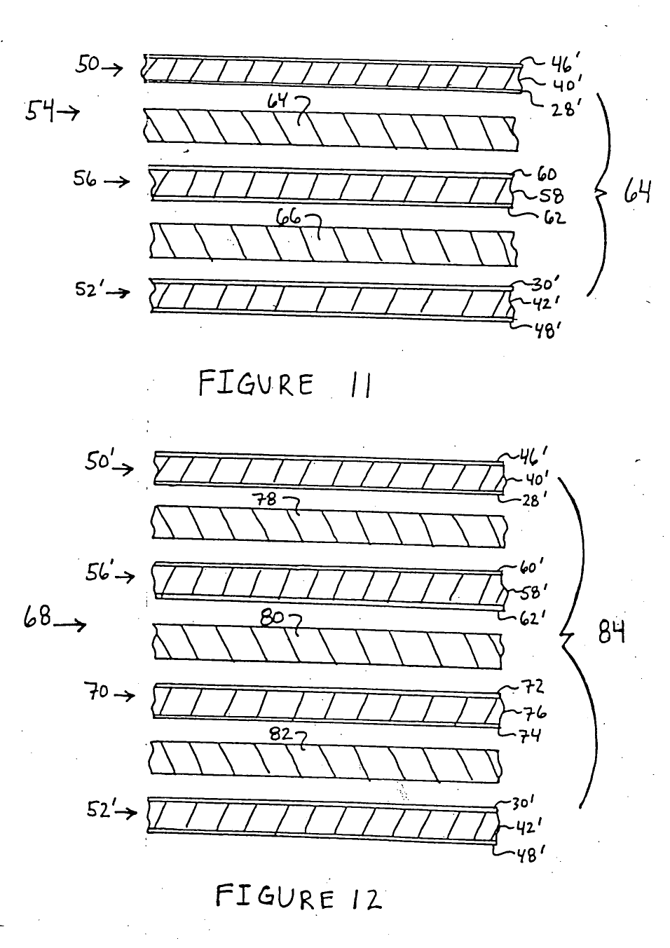

### FIELD OF THE INVENTION

The present invention relates to a resin composition having a high dielectric constant and uses thereof.

### BACKGROUND OF THE INVENTION

With the development of technology, various electronic products are designed to be lighter, thinner, shorter, smaller, and multi-functional. However, due to the increase in the number of various passive elements, especially the surface mount design (SMD) elements, e.g., resistors, capacitors, and inductometers, used on a printed circuit board, hundred of passive elements occupy an extremely large area on the surface of the printed circuit board even though their sizes have been continuously reduced. In order to eliminate such drawback, the passive elements are manufactured in a form of a film and then embedded in circuit boards, so as to effectively reduce the area 10 to 20 times and enhance the reliability due to reduced soldering points.

In the past, there were many researches as to embedding a capacitor in a printed circuit board. For example, ROC (Taiwan) Patent Publication No. 203677 discloses a process for manufacturing an internal capacitor, which utilizes two conductive foils and one intermediate dielectric layer and treats the same with heat and pressure to form a circuit board. However, this ROC patent does not mention what the materials useful in said dielectric layer are. Moreover, in this ROC patent, the conductor on the dielectric layer is required to be pre-etched and patterned, and then a multi-layer sheet is laminated. Such processing requires a larger wiring area and is not suitable for a build-up technique, which manufactures multi-layer printed circuit boards having small wire width and space and including blind holes.

To meet the demand for high density structure and package in the future, the trend of development of new technology is to embed the capacitor in the substrate, so as to increase the density of structure and package and reduce the wiring area. For an embedded capacitor material, current technology normally involves admixing ferro-electric ceramic powders, e.g., BaTiO₃ and PbTiO₃, with an insulating material, e.g., epoxy resin, to form a dielectric material, or immersing the same in glass fiber cloth to form a prepreg, for use in the manufacture of a capacitor layer embedded in a multi-layer printed circuit board. For example, U.S. Pat. No. 5,796,587 discloses a process for embedding a capacitor in a circuit board package. The material used in this patent is a mixture of 85 wt % BaTiO₃ powder with an epoxy resin. The material is coated on a conductor layer having pre-drill holes, followed by building up the same. A circuit board embedding a capacitor can be formed by a common lamination technique. U.S. Pat. No. 5,162,977 discloses the production of a printed circuit board including a high capacitance power distribution core and its packaging procedures. The high dielectric constant material is prepared from glass fiber impregnated with a resin liquid containing an epoxy resin and a ferro-electric ceramic powder.

The above-mentioned U.S. patents make an influence on the dielectric constant by changing the species, filling amount, and particle size of the ceramic powder. This technical means, however, has an limitation. That is, the ferro-electric ceramic powder, e.g., BaTiO₃ or its blend or dopant, is sintered only under a high temperature (about 1300° C.) or a low temperature (about 750° C.), such that the perovskite lattice structure exhibiting a high dielectric constant will be formed. Nonetheless, the processing temperature for the printed circuit board will not be greater than 250° C., which is much lower than the low sintering temperature. Under such a low temperature, the ferro-electric ceramic powder cannot form a high dielectric constant lattice. Therefore, the dielectric constant of the capacitor material embedded in a printed circuit board can not be high.

Moreover, although it is workable to enhance the dielectric constant by increasing the filling amount of the ceramic powder, the filling amount is often limited. If the filling amount is too high, the material becomes brittle and easily fractures, and thus is not suitable in the manufacture of printed circuit boards.

U.S. Pat. No. 5,800,575 discloses filling an insulating material with nanopowders to enhance the dielectric constant. Even though the use of nanopowders can enhance the filling density, thereby increasing the dielectric constant, the handling of the nanopowders is difficult. Moreover, since the viscosity of the resin liquid is increased due to the increase in specific surface area, it makes the filling more difficult and the filling amount will be extensively reduced.

Moreover, it is known that a polymer material can be added to ceramic powder to attain a high dielectric constant. Nonetheless, this technique also faces the problems associated with the filling technology of polymer powder, the controlling of rheological property of a resin material, and the dependency of material on temperature and humidity, and cannot obtain satisfactory results.

The admixing of materials can be represented by a mixing rule represented by Equation (1):

$${K}^{n} = {\sum }_{i} {v}_{i} {k}_{i}^{n} \qquad ( 1 )$$

wherein, v represents a volume fraction, and k is a dielectric constant, and
when n=−1, the equation represents a serial mixing rule;
when n=1, the equation represents a parallel mixing rule; and
when n=0, the equation represents a logarithmic mixing rule, which is also named Lichtenecker equation.

The mixing rule used in the capacitor material embedded in a printed circuit board is the logarithmic mixing rule. When the mixture only contains the two components, i.e., ceramic powder and resin matrix, Equation (1) can be interpreted to become Equation (2):
log K=Vₚlog Kₚ+Vₘlog Kₘ (2)

wherein Vₚ and Vₘ are the volume fractions of ceramic powder and resin matrix, respectively, and Kₚ and Kₘ are the dielectric constants of the ceramic powder and resin matrix, respectively.

The dielectric constants of common epoxy resins are not high. Moreover, since the upper limit of the volume fraction of the ceramic powder (Vₚ) is 50% or 60% and the dielectric constant of the ceramic powder (Kₚ) cannot be effectively increased due to the insufficiently high processing temperature, the dielectric constant of the capacitor material cannot be increased. Therefore, if the dielectric constant of the resin is enhanced, it can effectively increase the integral dielectric constant and significantly enhance the capacitance.

Upon the research, the inventors found that the addition of a highly polar modifier to a capacitor material can effectively increase the dielectric constant of the resin matrix (Kₘ), and thus obtain a capacitor material having a high dielectric constant and also overcome the drawbacks of the embedded capacitor materials of the prior art technology.

### DESCRIPTION OF THE INVENTION

The present invention aims to provide a composition comprising (a) an epoxy resin, (b) a curing agent, (c) a ceramic powder, and (d) a highly polar modifier. The composition of the subject invention has a high dielectric constant and is useful in a capacitor material embedded in printed circuit boards.

The amount of the epoxy resin contained in the composition of the subject invention, based on the total weight of the composition, ranges from 5 to 20 wt %, preferably from 7 to 15 wt %. The epoxy resin that can be used in the composition of the subject invention does not require any special limitation and can be a liquid epoxy resin, a solid epoxy resin, or a mixture thereof. Typically, suitable epoxy resins have an epoxy equivalent between 50 and 800 (g/eq), preferably between 130 and 500 (g/eq). The examples of the epoxy resin used in the subject invention include, but are not limited to, a bisphenol A epoxy resin, such as those under the trade names EPON 828 (Shell Oil Company), EPON 1001 (Shell Oil Company), and DER 331 (Dow Chemical Company); a tetrabromobisphenol A epoxy resin, such as those under the trade names DIC 153 (Dainippon Ink & Chemical Co.) and DIC 152 (Dainippon Ink & Chemical Co.); a bisphenol F epoxy resin, such as that under the trade name EPON 862 (Shell Oil Company); a cresol novolak epoxy resin, such as those under the trade names NPCN-703 and NPCN-704 (Nan Ya Plastics Corporation); a novolak epoxy resin, such as that under the trade name NPPN-638 (Nan Ya Plastics Corporation); a multi-functional epoxy resin, such as those under the trade names EPPN 501 (Nippon Kayaku Co.) and EPPN 502H (Nippon Kayaku Co.); and a dicyclopentadiene epoxy resin, such as those under the trade names XD-1000 2L (Nippon Kayaku Co.) and HP-7200L (Dainippon Ink & Chemical Co.); and a mixture thereof. The bisphenol A epoxy resin is preferred.

The amount of the curing agent contained in the composition of the subject invention, based on the total weight of the composition, ranges from 0.1 to 15 wt %, preferably from 7 to 12 wt %. The curing agent that can be used in the subject invention is selected from the group consisting of an acid anhydride compound, a phenolic resin having two or more functional groups, an aromatic diamine, and a latent curing agent for the epoxy resin. The curing agents can be used alone or in a mixture.

Examples of the acid anhydride used in the subject invention include, but are not limited to, hexahydrophthalic anhydride, methyl hexahydrophthalic anhydride, and maleic anhydride. The acid anhydride compounds can be used alone or in a mixture.

The phenolic resin having two or more functional groups used in the subject invention has a hydroxyl equivalent between 50 and 500 (g/eq), preferably between 100 and 300 (g/eq). The examples of the phenolic resin include, but not limited to, a meta-cresol phenolic resin, such as those under the trade names TD-2093 and TD-2090 (Dainippon Ink & Chemical Co.); a multi-functional phenolic resin, such as that under the trade name MEH-7500 (Meiwa Co.); and a dicyclopentadiene phenolic resin, such as those under the trade names DPP-M and DPP-L (Japan Petroleum Chemical Co.), and a mixture thereof.

Examples of the latent curing agent for the epoxy resin used in the subject invention include, but not limited to, dicyanodiamide, BF₃.Monoethylamine complex, imidazole and a derivative thereof, a triphenyl phosphite, copper (II) acetylacetate, N′,N′-dimethyl benzylamine, and 1,8-diazabicyclo -(5,4,0)-undec-7-ene and a salt thereof, and a mixture thereof

The amount of the ceramic powder contained in the composition of the subject invention, based on the total weight of the composition, ranges from 60 to 85 wt %, preferably from 64 to 74 wt %. The ceramic powder used in the composition of the subject invention normally has a particle size between 0.05 μm and 20 μm, preferably between 0.1 μm and 10 μm. The species of the ceramic powder are obvious to persons skilled in the art and may include aluminum hydroxide and a metal oxide, and a mixture thereof. Examples of the metal oxide used in the subject invention include, but not limited to, BaTiO₃, PbTiO₃, TiO₂, Al₂O₃, and PbO, and a mixture thereof, e.g., those under the trade names BT-4 (Nippon Chemical), XJ4000 (Ferro), YL12000 (Ferro), and TAMTRON Y5V183U (TAM Ceramic).

The amount of the highly polar modifier contained in the composition of the subject invention, based on the total weight of the composition, ranges from 1 to 10 wt %, preferably from 1 to 5 wt %. The highly polar modifier useful in the subject invention can be a monomer, oligomer, or polymer having an amino or a cyano group or a mixture thereof in the backbone or side chain of the molecule. The non-limiting examples include a cyano resin, such as that under the trade name CR-S (ShinEtsu), N-methyl acetamide, and acrylic nitrile. The amount of the amino group, based on the total weight of the highly polar modifier, ranges from 5 to 30 wt %, preferably from 7 to 20 wt %. The amount of the cyano group, based on the total weight of the highly polar modifier, ranges from 1 to 40 wt %, preferably from 5 to 20 wt %.

The composition of the subject invention may optionally comprise an additive known to persons skilled in the art, such as a promoter, defoamer, filler, dispersant, coupling agent, and organic solvent.

The filler used in the subject invention may be a conductive or non-conductive inorganic material, or metal or resin powder. The filler may also be helpful in enhancing the dielectric constant of a capacitor material.

The solvents which may be used in the subject invention are well known to persons skilled in the art. Suitable solvents include acetone, methyl ethyl ketone, dimethyl foramide, xylene, and methoxy propanol and a mixture thereof. The amount of the solvent contained in the composition of the subject invention, based on the total weight of the composition, normally ranges from 3 to 15 wt %.

The subject invention further relates to a process for manufacturing a printed circuit board, comprising using the composition of the subject invention as a capacitor material embedded in the printed circuit board. The use of the composition of the subject invention in the production of a printed circuit board not only avoids the problem associated with the brittleness of the material due to the increase in the filling amount of ceramic powder for enhancing the dielectric constant, but also obtains a printed circuit board in which a capacitor having a high dielectric constant is embedded.

The subject invention will be further described by the following examples. Nonetheless, it should be noted that the working examples are provided for a further illustration of the present invention, but not intended to limit the scope of the present invention.

### EXAMPLES

Table 1 lists the components of the formulation of each example. Formulation 1 is a control formulation without a highly polar modifier and ceramic powder. Formulations 2 to 6 incorporated highly polar modifiers in different proportions. Formulations 8 to 12 incorporated both ceramic powders and highly polar modifiers in different proportions.

TABLE 1
The Components of Formulations

| | | Curing agent | | Highly polar | | Ceramic |
|---|---|---|---|---|---|---|
| | Bisphenol A | (methyl | Curing agent | modifier | Solvent | powder |
| | epoxy resin | hexahydrophthalic | (N′,N′-dimethyl | (cyano resin | (dimethyl | (BaTiO₃ [XJ- |
| | (EPSON 828) | anhydride) | benzylamine) | [CR-S]) | foramide | 4000]) |
| F1 | 20 | 20 | 0.06 | ˜ | ˜ | ˜ |
| F2 | 20 | 20 | 0.06 | 2 | 6 | ˜ |
| F3 | 20 | 20 | 0.06 | 4 | 12 | ˜ |
| F4 | 20 | 20 | 0.06 | 6 | 18 | ˜ |
| F5 | 20 | 20 | 0.06 | 8 | 24 | ˜ |
| F6 | 20 | 20 | 0.06 | 12 | 36 | ˜ |
| F7 | 20 | 20 | 0.06 | ˜ | ˜ | 120 |
| F8 | 20 | 20 | 0.06 | 2 | 6 | 126 |
| F9 | 20 | 20 | 0.06 | 4 | 12 | 132 |
| F10 | 20 | 20 | 0.06 | 6 | 18 | 138 |
| F11 | 20 | 20 | 0.06 | 8 | 24 | 144 |
| F12 | 20 | 20 | 0.06 | 12 | 36 | 156 |

Unit: gram
F: formulation

Experimental procedure:
1. Stoichiometric epoxy resin, curing agent, highly polar modifier, ceramic powder and solvent were added to a container equipped with a stirrer and were stirred and dissolved under ambient temperature, and then the latent curing agent for the epoxy resin was added and uniformly stirred. The mixture was milled and dispersed with a tri-roller device, and was then placed statically and defoamed, so as to obtain resin compositions as those shown in Table 1.
2. A polyethylene terephthalate (PET) carrier film was placed upwards on a coaten. The docter blade was adjusted to allow coating thickness of the resin composition obtained from Step 1 to be 60 μm. The carrier film coated with the resin composition was baked in an oven at about 140° C. for 10 minutes. This step is conducted to remove the solvent and obtain a B-stage resin. The dried film has a thickness of 40 μm.
3. The B-stage resin on the PET film was released and milled with a mortar, and then sheeted under pressure with a die. The thickness of the resultant sheet was about 1 mm. The sheet was cured in an oven at 150° C. for 1 hour.
4. After being cooled, the thickness of the sheet was measured and then the sheet was placed in a vacuum gilding machine to allow its surface to be gilded. The dielectric constant (Dₖ) and dissipation factor (D_{f}) under high and low frequencies were respectively measured by HP-4291B meter and 4338 LCR meter.

5. The results of the experiments are shown in Table 2.

TABLE 2
Test Results

| | | | | D_{f} | D_{f} | D_{f} |
|---|---|---|---|---|---|---|
| | D_{K} (1 GHz) | D_{K} (100 MHz) | D_{K} (1 MHz) | (1 GHz) | (100 MHz) | (1 MHz) |
| F1 | 2.7826 | 2.8245 | 3.2822 | 0.0701 | 0.0209 | 0.0289 |
| F2 | 3.4139 | 3.6399 | 4.2695 | 0.03681 | 0.02216 | 0.0346 |
| F3 | 3.7558 | 4.1737 | 5.2014 | 0.05721 | 0.04006 | 0.0420 |
| F4 | 4.0546 | 4.6595 | 5.7732 | 0.07333 | 0.05932 | 0.0478 |
| F5 | 4.1046 | 4.7627 | 6.4409 | 0.07495 | 0.06289 | 0.0502 |
| F6 | 5.5727 | 7.3959 | 8.7241 | 0.15367 | 0.10666 | 0.0546 |
| F7 | 15.5370 | 15.5850 | 15.5241 | 0.01725 | 0.01199 | 0.0290 |
| F8 | 18.9520 | 20.7990 | 21.6720 | 0.06164 | 0.04213 | 0.0387 |
| F9 | 20.5650 | 21.8020 | 24.5740 | 0.07870 | 0.05446 | 0.0531 |
| F10 | 23.4980 | 28.4220 | 31.2103 | 0.13348 | 0.09296 | 0.0780 |
| F11 | 27.7800 | 31.3150 | 33.9722 | 0.09345 | 0.07476 | 0.0853 |
| F12 | 31.2900 | 35.4200 | 38.0705 | 0.09261 | 0.07848 | 0.0976 |

F: formulation

Conclusion:
1. By comparing the test results of F1 and F7, the capacitor material containing a ceramic powder has a higher dielectric constant. It shows that the ceramic powder can enhance the dielectric constant of the material.
2. By comparing the test results of F1 with F2 to F6, the capacitor material containing a cyano resin has a slightly enhanced dielectric constant. It shows that the highly polar modifier can, though not significantly, enhance the dielectric constant of the capacitor material.
3. By comparing the tests results of F2 to F6 with F8 to 12, the addition of both a ceramic powder and highly polar modifier can significantly enhance the dielectric constant of the capacitor material. It shows that the addition of both the ceramic powder and highly polar modifier can obtain a capacitor material having a high dielectric constant.

The attached claims define the reasonable scope of protection of the subject invention. However, it should be understood that all obvious improvements which persons skilled in the art can attain based on the disclosures of the subject invention should fall in the reasonable scope of protection of the subject invention.

1. A resin composition comprising
(a) an epoxy resin, (b) a curing agent, (c) a ceramic powder, and (d) a highly polar modifier.

2. The composition of claim 1, wherein the epoxy resin is a liquid epoxy resin or a solid epoxy resin or a mixture thereof, and has an epoxy equivalent between 50 and 800 g/eq.

3. The composition of claim 1, wherein the epoxy resin is selected from a bisphenol A epoxy resin, a tetrabromobisphenol A epoxy resin, a bisphenol F epoxy resin, a cresol novolak epoxy resin, a novolak epoxy resin, a multi-functional epoxy resin, and a dicyclopentadiene epoxy resin, and a mixture thereof.

4. The composition of claim 1, wherein the curing agent is selected from the group consisting of an acid anhydride compound, a phenolic resin containing two or more functional groups, an aromatic diamine, a latent curing agent for epoxy resin, and a mixture thereof.

5. The composition of claim 4, wherein the acid anhydride compound is selected from the group consisting of hexahydrophthalic anhydride, methyl hexahydrophthalic anhydride, maleic anhydride, and a mixture thereof.

6. The composition of claim 4, wherein the phenolic resin containing two or more functional groups has a hydroxyl equivalent between 50 and 500 g/eq and is selected from the group consisting of a meta-cresol phenolic resin, a multi-functional phenolic resin, a dicyclopentadiene phenolic resin, and a mixture thereof.

7. The composition of claim 4, wherein the latent curing agent for the epoxy resin is selected from the group consisting of dicyanodiamide, BF₃.Monoethylamine complex, imidazole and a derivative thereof, triphenyl phosphite, copper (II) acetylacetate, N′,N′-dimethyl benzylamine, and 1,8-diazabicyclo-(5,4,0)-undec-7-ene and a salt thereof, and a mixture thereof.

8. The composition of claim 1, wherein the ceramic powder has a particle size between 0.05 μm and 20 μm and is aluminum hydroxide, a metal oxide, or a mixture thereof.

9. The composition of claim 8, wherein the metal oxide is selected from the group consisting of BaTiO₃, PbTiO₃, TiO₂, Al₂O₃, PbO, and a mixture thereof.

10. The composition of claim 1, wherein the highly polar modifier is a monomer, oligomer, or polymer having an amino or a cyano group in the backbone or side chain of the molecule, or a mixture thereof.

11. The composition of claim 13, wherein the amount of the amino group, based on the total weight of the highly polar modifier, is from 5 to 30 wt %, and the amount of the cyano group, based on the total weight of the highly polar modifier, is from 1 to 40 wt %.

12. A composition for use as a capacitor material having a high dielectric constant and embedded in a printed circuit board, comprising:
(a) an epoxy resin with an epoxy equivalent between 50 and 800 g/eq;
(b) a curing agent; and
(c) a ceramic powder having a particle size between 0.05 and 20 μm,
characterized in that the composition comprises (d) a highly polar modifier, wherein the highly polar modifier is a monomer, oligomer, or polymer having an amino or a cyano group in its backbone or side chain, or a mixture thereof.

13. The composition of claim 12, wherein the epoxy resin is a liquid epoxy resin, a solid epoxy resin, or a mixture thereof and has an epoxy equivalent between 130 and 500 g/eq.

14. The composition of claim 12, wherein the epoxy resin is selected from a bisphenol A epoxy resin, a tetrabromobisphenol A epoxy resin, a bisphenol F epoxy resin, a cresol novolak epoxy resin, a novolak epoxy resin, a multi-functional epoxy resin, a dicyclopentadiene epoxy resin, and a mixture thereof.

15. The composition of claim 12, wherein the curing agent is selected from the group consisting of an acid anhydride compound, a phenolic resin containing two or more functional groups, an aromatic diamine, a latent curing agent for epoxy resin, and a mixture thereof.

16. The composition of claim 15, wherein the acid anhydride compound is selected from the group consisting of hexahydrophthalic anhydride, methyl hexahydrophthalic anhydride, maleic anhydride, and a mixture thereof.

17. The composition of claim 16, wherein the phenolic resin containing two or more functional groups has a hydroxyl equivalent between 50 and 500 g/eq and is selected from the group consisting of a meta-cresol phenolic resin, a multi-functional phenolic resin, a dicyclopentadiene phenolic resin, and a mixture thereof.

18. The composition of claim 15, wherein the latent curing agent for the epoxy resin is selected from the group consisting of dicyanodiamide, BF₃.Monoethylamine complex, imidazole and a derivative thereof, triphenyl phosphite, copper (II) acetylacetate, N′,N′-dimethyl benzylamine, 1,8-diazabicyclo-(5,4,0)-undec-7-ene and a salt thereof, and a mixture thereof.

19. The composition of claim 12, wherein the ceramic powder has a particle size between 0.1 μm and 10 μm and is aluminum hydroxide, a metal oxide, or a mixture thereof.

20. The composition of claim 19, wherein the metal oxide is selected from the group consisting of BaTiO₃, PbTiO₃, TiO₂, Al₂O₃, PbO, and a mixture thereof.

21. The composition of claim 12, wherein the amount of the amino group, based on the total weight of the highly polar modifier, is from 5 to 30 wt % and the amount of the cyano group, based on the total weight of the highly polar modifier, is from 1 to 40 wt %.

22. The composition of claim 12, further comprising an additive.

23. The composition of claim 12, wherein the additive is selected from the group consisting of a promoter, a defoamer, a filler, a dispersant, a coupling agent, an organic solvent, and a mixture thereof.

24. The composition of claim 23, wherein the organic solvent is selected from acetone, methyl ethyl ketone, dimethyl foramide, xylene, methoxy propanol, and a mixture thereof.

25. A process for manufacturing a printed circuit board, comprising using the composition of claim 1 in a capacitor material embedded in the printed circuit board.

26. A process for manufacturing a printed circuit board comprising using the composition of claim 12 in a capacitor material embedded in the printed circuit board.
